(19) United States
(12) Patent Application Publication
(10) Pub. No.: US 2012/0021387 A1
(43) Pub. Date: Jan. 26, 2012

(54) PAINT SET

(75) Inventors: Kunio Watanabe, Kanagawa-Ken (JP); Naoharu Ohsako, Kanagawa-Ken (JP); Yoshiaki Shimonaka, Tokyo (JP)

(73) Assignees: Kohoku Kogyo Co, Ltd, Nagahama-Shi (JP); Yokama National University, Yokohama-Shi (JP)

(21) Appl. No.: 13/145,902

(22) PCT Filed: Jan. 20, 2010
(86) PCT No.: PCT/JP2010/050613

§ 371 Date: Oct. 11, 2011

(30) Foreign Application Priority Data
Jan. 22, 2009 (JP) 2009-011672

(51) Int. Cl. G09B 19/00

(52) U.S. Cl. 434/98

(57) ABSTRACT

Provided is a paint set that can allow optimal colors to be easily selected, mixed and arranged and, at the same time, can attain a learning effect about three attributes of colors or a hue circle even during work production. A plurality of chromatic color paints each having a hue are arranged circularly in a storage case to constitute a hue circle.

### TECHNICAL FIELD

The present invention relates to a paint set for teaching materials used, of course, in curricula for compulsory education, as well as in education curricula in high schools and more specifically to a paint set comprising paint vessels for respective colors, the paint vessels being circularly arranged to constitute a hue circle.

### BACKGROUND ART

In lesson processes of art in junior high schools and the like, color education is carried out in which pupils or students experience creative endeavors through the production of works such as paintings and designs, or understand three attributes (hue, brightness, and chroma) of colors, and hue circles. Education on colors, for example, in art classes intended for first-year junior high-school students offers an understanding of three attributes of colors, hue circles, complementary colors, color mixtures, contrast of colors, impressions of colors and the like and offers an understanding of a color change by replacement with a two-dimensional or three-dimensional space, and, thereafter, experiential learning is carried out about colors through the production of works.

The effect (purpose) of learning about three attributes of colors and hue circles includes i) that properties inherently possessed by colors that are uninterruptedly circulated can be visually (intuitively) understood and a color change can be spatially recognized, ii) that a color produced by mixing two colors can be estimated before paints are actually mixed together, and iii) that, regarding a complementary color relationship and contract of colors can be spatially recognized by a positional relationship between colors. In art classes, a teaching method is adopted in which understanding by pupils or students is improved using materials for color education, for example, Munsell hue circles and hue circles of Japanese Practical Color Co-ordinate System (hereinafter referred to also as “PCCS”).

In the production of works such as paintings and designs, a paint set comprising paints of several to more than ten colors is usually used. Pupils or students select a plurality of color paints, and these color paints are mixed together on a palette to prepare a desired color before paintings are produced. A commonly used paint set comprises cylindrical tubes filled with respective paints that are arranged side by side so that similar colors are located adjacent to each other. Pupils or students select or mix colors based on color information (color label or color name) indicated on the surface of the tube.

Such paint vessels include those in which a paint is filled into a conventional tin vessel or a recent cylindrical tube of an aluminum-laminated film. In recent years, paint vessels comprising a paint filled into a resin vessel formed by blow molding have been proposed (Japanese Patent Application Laid-Open Nos. 230907/1996 and 250085/2004). Further, for example, a paint case in which paints of various colors are juxtaposed and housed (Japanese Patent Application Laid-Open No. 86100/1997). Furthermore, teaching aids that can allow a change in hue or a change in brightness and chroma by mixing colors to be learned without the necessity for pupils or students to use paints have been proposed as materials for color education (Japanese Patent Application Laid-Open No. 183392/2007).

### PRIOR ART DOCUMENTS

### Patent Documents

Patent document 1: Japanese Patent Application Laid-Open No. 230907/1996
Patent document 2: Japanese Patent Application Laid-Open No. 250085/2004
Patent document 3: Japanese Patent Application Laid-Open No. 86100/1997
Patent document 4: Japanese Patent Application Laid-Open No. 183392/2007

### DISCLOSURE OF THE INVENTION

### Problems to be Solved by the Invention

In producing works using paints, however, it is necessary to mix a plurality of color paints to prepare a desired color. For pupils or students who do not experience satisfactory learning of colors or pupils or students who do not have satisfactory understanding about three attributes of colors, hue circles, complementary colors, color mixing, and contrast of colors, difficulties are encountered in predicting paints of colors that are to be selected from a paint set and then mixed together to prepare a desired color. This necessitates selecting and mixing of actual paints to confirm whether or not a desired color can be obtained.

Further, paints can be mixed for color mixing using examples from hue circles described, for example, in textbooks. The production of works using examples from textbooks and the like is not practical and poses a problem that it is impossible to focus attention on the production of works. A method can be also adopted in which a small hue circle sample is placed on a pallet or within a paint set and paints are mixed for color mixing using the hue circle. In this method, however, the paint set and the hue circle sample (instrument) should be purchased separately from each other. Accordingly, a troublesome task is required for the provision of them, and a problem of cost also occurs.

Furthermore, in conventional teaching aids and teaching materials for hue circles, regardless of a text type or a suspension type, each color is directly printed, or a print is applied and fixed. Accordingly, each color cannot be moved. As a result, it is impossible to place colors adjacent to each other or to mix colors together.

The present inventors have now found that the provision of a paint set comprising paint vessels of respective colors circularly arranged so as to correspond to a hue circle can solve the above problems. The present invention has been made based on such finding.

Accordingly, an object of the present invention is to provide a paint set that can allow even pupils or students, who do not have satisfactory learning of colors, and even pupils or students, who have unsatisfactory learning experience or knowledge, for example, about three attributes of colors, hue circles, complementary colors, color mixtures and contrast of colors, to easily perform selection and color mixing or color arrangement of desired colors and, at the same time, can allow a learning effect on three attributes of colors and hue circles to be obtained during the production of works.

### Means for Solving the Problems

The paint set according to the present invention comprises a plurality, of paint vessels respectively filled with chromatic color paints each having a hue, the paint vessels being arranged circularly in a storage case to constitute a hue circle.

In a preferred embodiment of the present invention, the hue circle is a hue circle of a Munsell color system or a hue circle of the Chamber of Commerce & Industry Color Coordination Chart (CCIC) color system, a hue circle of a natural color system (NCS), or an Ostwald hue circle.

In another preferred embodiment of the present invention, the hue circle is a hue circle of a practical color co-ordinate system (PCCS).

In a preferred embodiment of the present invention, the number of colors of the plurality of chromatic color paints is 10, 12, 20, or 24.

In a preferred embodiment of the present invention, paint vessels respectively filled with chromatic color paints are tightly arranged adjacent to each other.

In a preferred embodiment of the present invention, the vessels each comprise a lid and a vessel body and has been filled with a paint and the vessel body comprises a pair of surfaces formed in a wedge shape from the upper part of an opening engaged with the lid toward the bottom and a pair of rectangular side surfaces that connect the wedge-shaped surfaces.

In a preferred embodiment of the present invention, the chromatic color paint vessels are arranged so that one of the pair of wedge-shaped surfaces in the vessel body faces upward relative to the storage case.

In a preferred embodiment of the present invention, the chromatic color paint vessels are arranged so that the lid faces outward in the circle.

In a preferred embodiment of the present invention, the vessels each comprise a lid and a vessel body and has been filled with a paint and the vessel body comprises a pair of surfaces in a trapezoidal shape widen from the upper part of an opening engaged with the lid toward the end and a pair of wedge-shaped side surfaces that is formed from the upper part of the opening toward the bottom and connects the trapezoidal surfaces.

In a preferred embodiment of the present invention, the chromatic color paint vessels are arranged so that one of the pair of trapezoidal surfaces in the vessel body faces upward relative to the storage case.

In a preferred embodiment of the present invention, the chromatic color paint vessels are arranged so that the lid faces inward in the circle.

In a preferred embodiment of the present invention, the chromatic color paint vessels are arranged in the storage case so that the surface, in the vessel body, that faces upward relative to the storage case is flat.

In a preferred embodiment of the present invention, the vessel body is formed of a transparent or semi-transparent resin and the hue of the paint filled into the vessel can be perceived through the appearance of the vessel body.

In a preferred embodiment of the present invention, the paint set further comprises a paint vessel that is filled with an achromatic paint and is provided at a position different from the position of the paint vessels filled with the chromatic color paints. In a more preferred embodiment of the present invention, the color of the achromatic paint is white and/or black.

According to another aspect of the present invention, there is provided a paint set characterized by comprising a plurality of paint vessels respectively filled with chromatic color paints each having a hue, the plurality of paint vessels being circularly arranged to constitute a hue circle.

### Effect of the Invention

The paint set according to the present invention comprises a plurality of paint vessels respectively filled with chromatic color paints, the paint vessels being arranged circularly in a storage case to constitute a hue circle and thus can allow even pupils or students, who do not have satisfactory learning of colors, and even pupils or students, who have unsatisfactory learning experience or knowledge, for example, about three attributes of colors, hue circles, complementary colors, color mixtures and contrast of colors, to easily perform selection and color mixing or color arrangement of desired colors and, at the same time, can allow a learning effect on three attributes of colors and hue circles to be obtained during the production of works.

According to the paint set of the present invention, paint vessels for respective colors can be taken out separately from each other and can be moved. Accordingly, the paint set of the present invention can fully make up for the problems involved in conventional teaching aids and teaching materials for hue circles, can compare colors on hue circles and can simply simulate the intensity of contrast between colors and can realize very specific and practical color learning effect through the use of actual colors (paints) per se.

According to the present invention, the paint set can also function as a learning material for colors that can allow colors to be gradually spatially perceived by simply possessing or using the paint set.

### BRIEF DESCRIPTION OF THE DRAWINGS

FIG. 1 is an overall view of one embodiment of a paint set according to the present invention.

FIG. 2 is an overall view of another embodiment of a paint set according to the present invention.

FIG. 3 is an overall view of still another embodiment of a paint set according to the present invention.

FIG. 4 is an overall view of a further embodiment of a paint set according to the present invention.

FIG. 5 is an overall view of a still further embodiment of a paint set according to the present invention.

FIG. 6 is an overall view of another embodiment of a paint set according to the present invention.

FIG. 7 is an overall view of still another embodiment of a paint set according to the present invention.

FIG. 8 is an overall view of a further embodiment of a paint set according to the present invention.

FIG. 9 is an overall view of a still further embodiment of a paint set according to the present invention.

FIG. 10 is an overall view of another embodiment of a paint set according to the present invention.

FIG. 11 is an overall view of still another embodiment of a paint set according to the present invention.

FIG. 12 is an overall view of a further embodiment of a paint set according to the present invention.

### BEST MODE FOR CARRYING OUT THE INVENTION

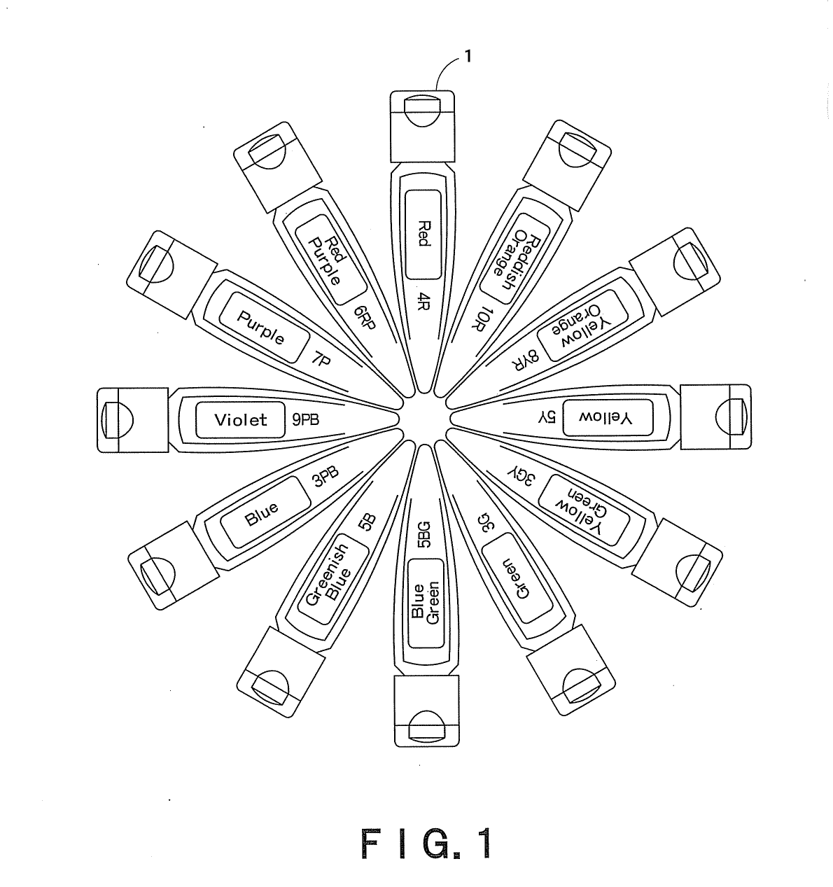

The paint set according to the present invention will be described with reference to the accompanying drawings. As shown in FIG. 1, the paint set according to the present invention comprises a plurality of paint vessels 1 respectively filled with chromatic color paints each having a hue, the paint vessels being arranged circularly in a storage case to constitute a hue circle. In a conventional paint set comprising paints having respective hues horizontally arranged in one line or in a plurality of lines, a color change in a lateral direction can be understood in a given range, but on the other hand, connection of paints arranged at both ends cannot be understood without difficulties. A circular arrangement of paints so as to constitute a hue circle can allow a space inherently possessed by uninterruptedly circulated colors to be easily visually perceived, relatively grasped, and understood. Further, a combination of complementary color relationships that dually face in an opposed positional relationship on a hue circle can be intuitively understood. Accordingly, optimal color selection and color mixing can be easily carried out even by pupils or students, who do not experience satisfactory learning of colors, and by pupils or students, who have unsatisfactory knowledge, for example, about three attributes of colors, hue circles, complementary colors, color mixtures and contrast of colors.

Hue circles include a hue circle of a Munsell color system or a hue circle of the Chamber of Commerce & Industry Color Coordination Chart (CCIC) color system in which colors located at opposed positions on the hue circle are in a physically complementary color relationship; or a hue circle of a practical color co-ordinate system (PCCS), a hue circle of a natural color system (NCS), or an Ostwald hue circle in which colors located at opposed positions on the hue circle are in a psychologically complementary color relationship.

For example, when chromatic color paint vessels are arranged so as to constitute a hue circle of a Munsell color system which is a hue circle comprising colors arranged so that opposed positions on the circle are in a physical complementary color relationship, the paint vessels may be arranged so that, according to notation of a Munsell color system specified in JIS Z 8721, basic colors and complementary colors thereof are nR-nBG, nYR-nB, nY-mPB, nGY-nP, and nG-nRP wherein n is an actual number, and colors constituting each of the combinations are located opposite to each other on the circle. Specifically, when chromatic color paints of 10 colors are used, five basic colors (R, YR, Y, GY, and G) are arranged respectively in five equal divided parts of a circle, and complementary colors (BG, B, PB, P, and RP) of the basic colors are arranged at positions opposite to the respective basic colors. The number of chromatic color paints is not particularly limited, but it is common practice to constitute the paint by 10 colors or 20 colors.

When chromatic color paint vessels are arranged so as to constitute a hue circle of a PCCS color system that is a hue circle comprising colors arranged so that the opposed positions on the circle are in a psychological color relationship, a method may also be adopted in which each hue of the PCCS color system is converted to a notation method for Munsell system (JIS standards) and, as described above, the chromatic color paint vessels may be arranged so that the colors constituting each combination of a basic color and a complementary color are located opposite to each other. Further, as shown in FIG. 1, when chromatic color paints of 12 colors are used, red, reddish orange, yellowish orange, yellow, yellowish green, green, blue-green, greenish blue, blue, violet-blue, purple, and reddish violet are arranged respectively in 12 equal divided parts of a circle. The number of chromatic color paints is not particularly limited, but it is common practice to constitute the paint set by 12 colors or 24 colors.

Specifically, when chromatic color paints of 12 colors are used, paints of four psychological primary colors (4R, 5Y, 3G, and 3PB in a Munsell color system) are circularly arranged as basic colors and paints of four psychological complementary colors (5BG, 9PB, 6RP, and 8YR in a Munsell color system) of the basic colors are arranged at positions opposite to the basic colors. Further, in order that the spacing between hues is perceptually moved at a uniform walking rate, a paint of 10R is placed between paints of 4R and 8YR; a paint of 3GY is placed between paints of 5Y and 3G; a paint of 5B is placed between paints of 5BG and 3PB; and a paint of 7P is placed between paints of 9PB and 6RP. In a commercially available paint set, when paints including all colors of four psychological primary colors and psychological complementary colors thereof are not provided, that is, some paints are not provided, it is difficult to circularly arrange the paint set, making it difficult to obtain the same form as the PCCS hue circle.

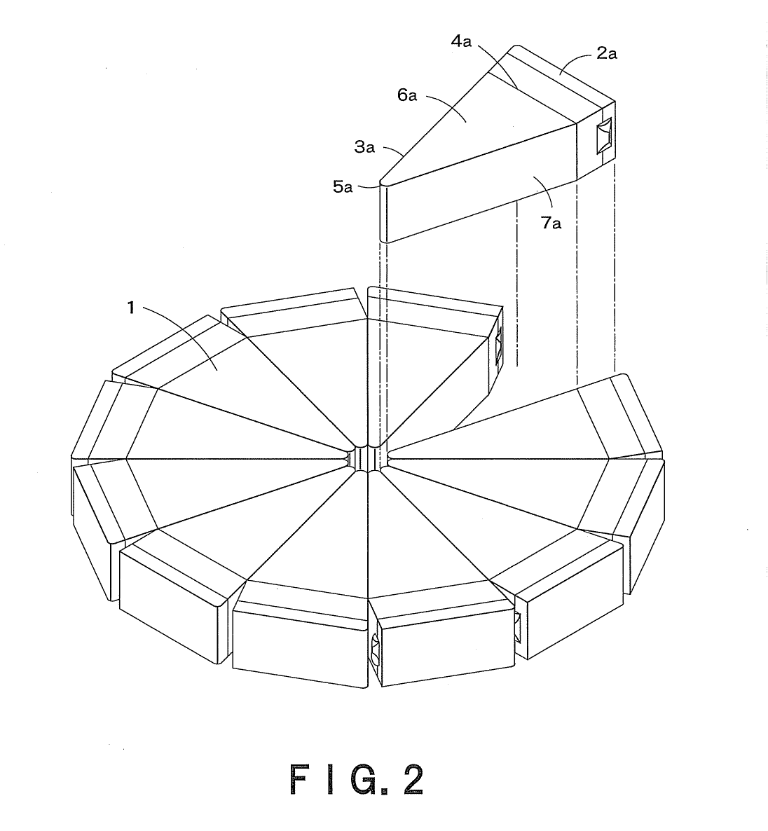

In the present invention, as shown in FIG. 2, preferably, adjacent chromatic color paint vessels are arranged without space. In a conventional tubular paint as shown in FIG. 1, since color labels indicated on the paints are small, even when the paints are arranged so as to constitute a hue circle, color labels are not continued to each other. Consequently, it is difficult to imagine color arrangement of the hue circle. As shown in FIG. 2, when adjacent paint vessels are arranged without space, color labels indicated on the paint vessels arranged so as to constitute a hue circle are continued to each other. Consequently, it is easy to imagine a hue circle, and the paint set per se can be beneficially utilized as color learning materials.

As shown in FIG. 2, a vessel comprising a lid 2a and a vessel body 3a, the vessel body 3a comprising a pair of surfaces 6a formed in a wedge shape from the upper part of an opening 4a engaged with the lid 2a toward the bottom 5a and a pair of rectangular side surfaces 7a that connect the wedge-shaped surfaces 6a, may be used as the paint vessels in which, as described above, adjacent paints are arranged without any space. When such paint vessels are used, preferably, one of the pair of wedge-shaped surfaces 6a in the vessel body faces upward relative to the storage case. As shown in FIG. 2, since the wedge-shaped surface 6a in the vessel faces upward relative to the storage case, the color label indicating the color of the content of the paint can be visually perceived as a flat surface. Accordingly, as compared with the indication of the color label on the cylindrical tubular vessel, the color of the paint can be accurately grasped regardless of the brightness of the illumination and the reflection of light. When such paint vessels are used, in order to arrange paints so as to constitute a hue circle, the paints may be disposed so that the lid 2a faces outward in the circle.

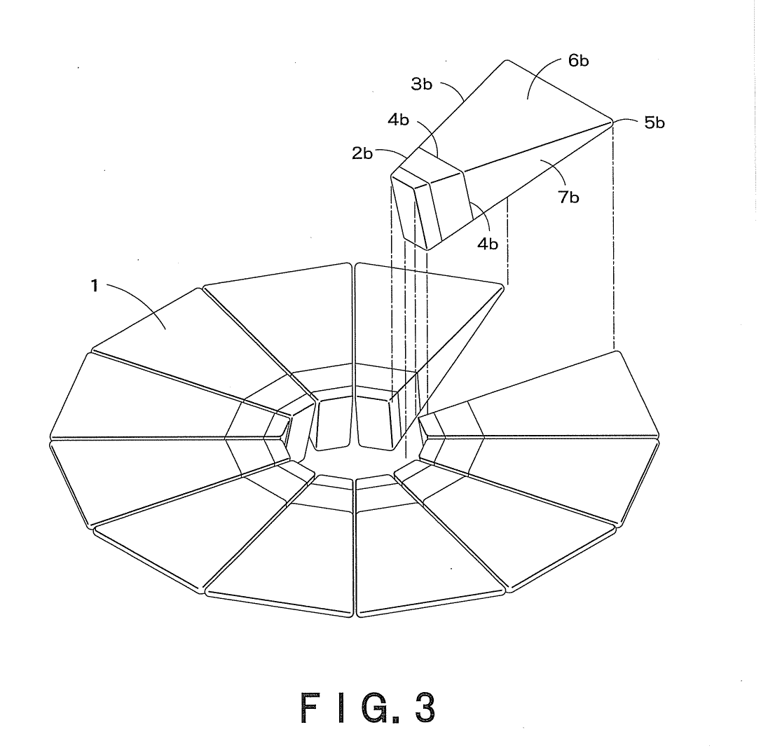

In another embodiment of the present invention, paint vessels in which adjacent paints are arranged without space may be as shown in FIG. 3. Specifically, the paint vessels each comprises a lid 2b and a vessel body, and the vessel body comprises a pair of surfaces 6b in a trapezoidal shape widen from the upper part of an opening 4b engaged with the lid 2b toward the end and a pair of wedge-shaped side surfaces 7b that are formed from the upper part of the opening 4b toward the bottom and connects the trapezoidal surfaces 6b. When such paint vessels are used, preferably, one of the pair of trapezoidal surfaces 6b in the vessel body faces upward relative to the storage case. As with the above embodiment, since the trapezoidal surface 6b faces upward relative to the storage case, the color label indicating the color of the content of the paint can be visually perceived as a flat surface. Accordingly, as compared with the indication of the color label on the cylindrical tubular vessel, the color of the paint can be accurately grasped regardless of the brightness of the illumination and the reflection of light. When such paint vessels are used, in order to arrange paints so as to constitute a hue circle, the chromatic color paints may be disposed so that the lid faces inward in the circle.

As shown in FIG. 2 or 3, preferably, the paints are arranged in the storage case so that surfaces (6a, 6b), in the vessel body, which face upward relative to the storage case are flat. When the surface of the paint vessel has concaves and convexes, depending upon the brightness of illumination or the degree of light reflection, in some cases, colors of the paints constituting the hue circle cannot be accurately grasped. When the paint vessels are arranged so that the upper surface of each of the paint vessels is flat, the hue circle as the whole surface can be recognized and, regardless of the brightness of illumination or light reflection, each color can be accurately grasped.

When color labels for color indication are applied on the paint vessels, preferably, color labels are applied onto at least two or more surfaces of each of the vessels. More preferably, the label is applied onto two continuous surfaces. When the color label is applied to two or more surfaces of each of the vessels, the paints per se can be utilized as three-dimensional color samples. Specifically, shade and shadow occur depending upon how the paint vessels are irradiated with light. When the color label is applied onto two or more surfaces of each of the vessels, the difference in brightness between the surfaces can be specifically recognized and, thus, the brightness of colors can be regulated while observing the vessels. Therefore, in the production of works, color arrangement plan and study works can be carried out in a more rapid, intuitively and efficient manner.

In the present invention, preferably, the paint vessel body is formed of a transparent or semi-transparent resin and the color of the paint to be filled into the paint vessel can be recognized through an appearance of the paint vessel. When the transparent or semi-transparent vessel body is used, the color of the paint filled into the vessel can be grasped through the appearance of the paint vessel. Accordingly, the color of the actual paint can be more accurately grasped without relying upon color labels. The paints per se can also be utilized as the color label. Since the color of the paint can be grasped through the whole surface of the vessel, a superior effect as a three-dimensional color sample can be attained. Further, in the paint vessel as shown in FIG. 2 or 3, acute angled portions (5a, 5b) are present in a part of the vessel, and, thus, color arrangement study works can be carried out even in a relatively narrow surface.

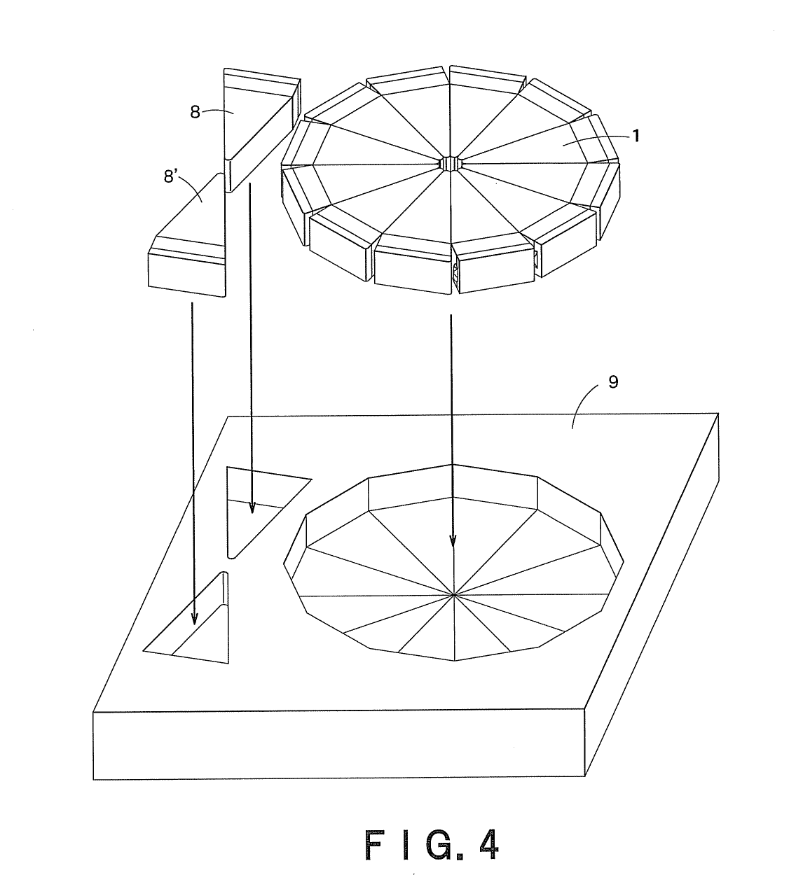

The paint set according to the present invention may further comprise a paint vessel filled with an achromatic paint. Achromatic paints include white and/or black paints. More preferred are white and black paints. The addition of white and black achromatic paints can realize a wide variety of color mixing while taking into consideration a change in brightness and a change in chroma. When these achromatic paint vessels 8, 8′ are arranged in a storage case 9, as shown in FIG. 4, the achromatic paint vessels 8, 8′ may be arranged separately from the chromatic color paint vessel 1.

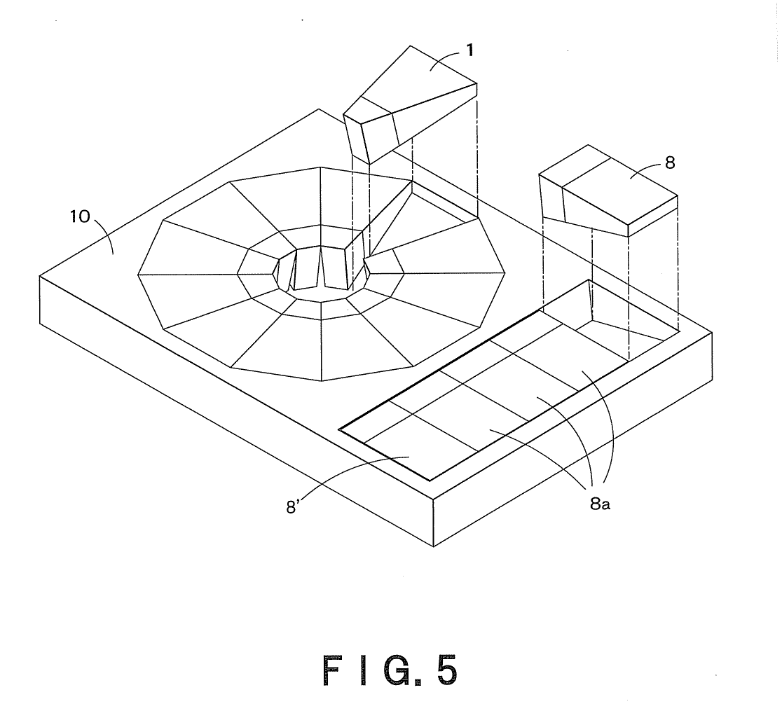

FIG. 5 is a perspective view of another embodiment of a paint set according to the present invention. In this embodiment, in addition to achromatic (white and black) paint vessels 8, 8′ shown in FIG. 4, a plurality of gray paint vessels 8a are added as achromatic paint vessels. When the plurality of gray paint vessels 8a are arranged, the paint vessels may be arranged between the white color and the black color so that a gray scale indicating a brightness stage is provided.

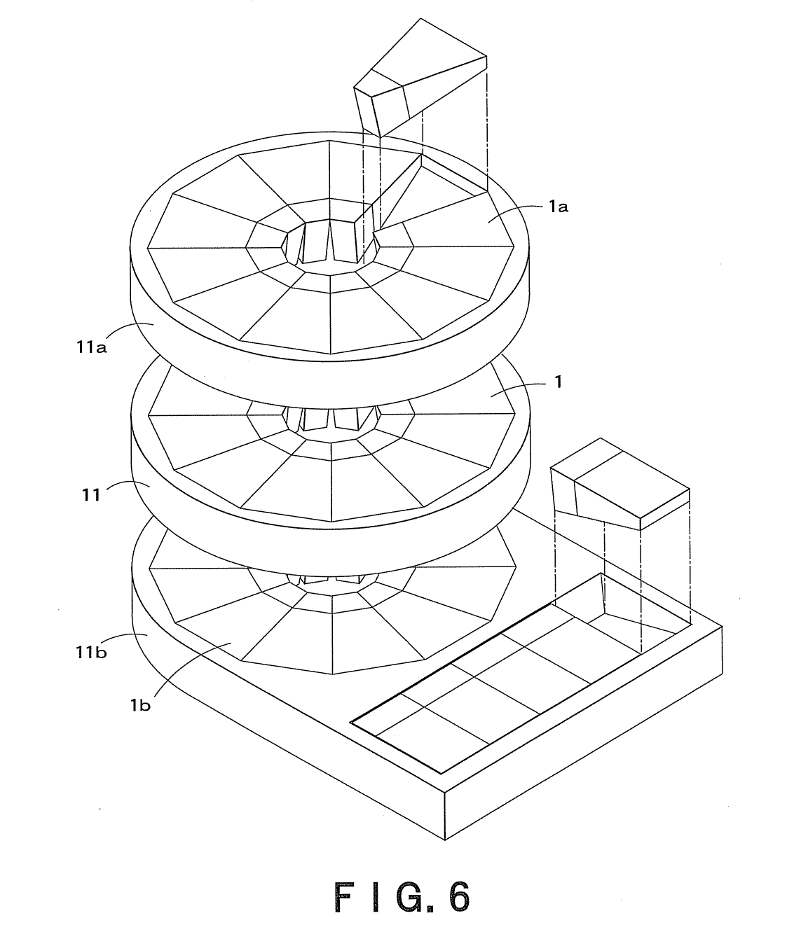

FIG. 6 is a perspective view of still another embodiment t of a paint set according to the present invention. The paint set shown in FIG. 6 has the same construction as the paint set shown in FIG. 5, except that storage cases 11 and 11a for chromatic color paint vessels circularly arranged so as to constitute a hue circle are added to constitute a three-layered structure of storage cases in which chromatic color paints vessels are circularly arranged. In the individual storage cases 11b, 11, and 11a, the chromatic color paint vessels are circularly arranged so as to constitute a hue circle. Chromatic color paint vessels different from each other in brightness or tone are respectively arranged in the three storages cases 11b, 11, and 11a. Thus, the arrangement of the storage cases 11b, 11, and 11a for paint vessels circularly arranged so as to constitute a hue circle in a multi-stage structure, the stages being different from each other in brightness or tone, can realize a three-dimensional hue circle assembly as a whole. Accordingly, a high learning effect on three attributes of colors and hue circles and a high level of function that can realize rapid color selection can be obtained.

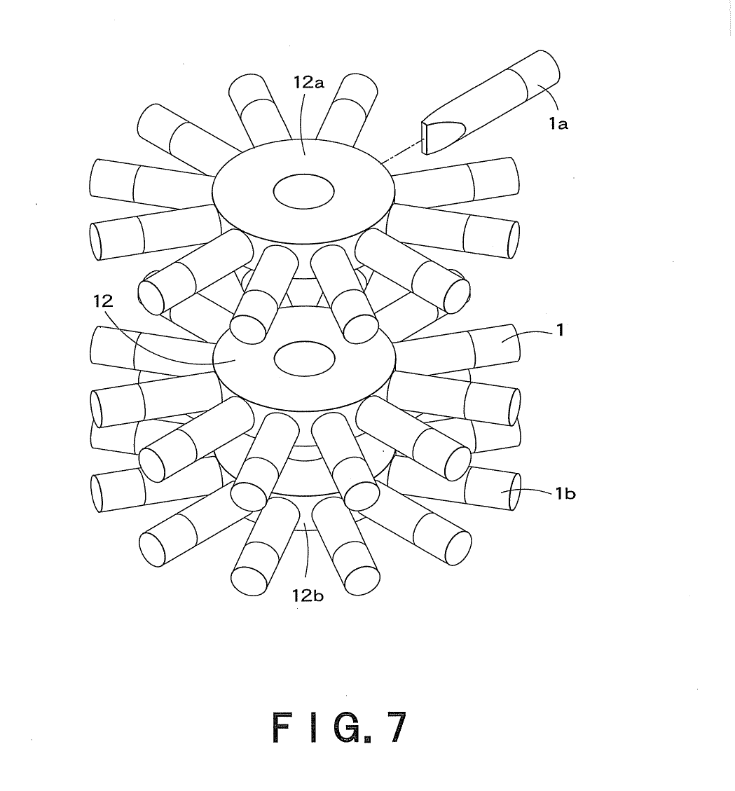

FIG. 7 is a perspective view of a further embodiment of a paint set according to the present invention. In the present invention, a storage case 12 having a shape into which one end of a tubular paint vessel 1 is fitted may also be used as a storage case for paint vessels. For example, a paint set may be prepared by forming holes on a side surface part of an annular storage case so as to divide the storage case into 12 equal parts and inserting the tubular paint vessels 1 into the holes to radially arrange the paint vessels. A method may also be adopted in which a plurality of paint vessel storage cases 12, 12a, and 12b that have been radially arranged are provided and, as with the embodiment shown in FIG. 6, are arranged in a multi-stage form so that the stages are different from each other in brightness or tone. According to the paint set in this embodiment, a three-dimensional hue circle assembly is formed as a whole, and, thus, a higher learning effect on three attributes of colors and hue circles and a high function of rapid color selection can be obtained.

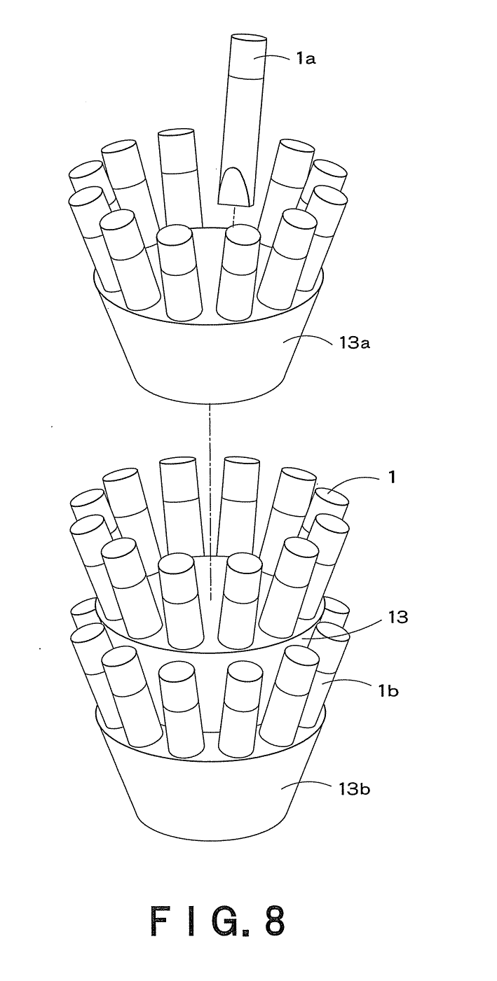

FIG. 8 is a perspective view of a further embodiment of a paint set according to the present invention. In this embodiment, the shape of the paint vessel storage case is different from the shape of the paint vessel storage case shown in FIG. 7. In this embodiment, the paint set has the following structure. The paint vessel storage case is in a truncated cone shape. Holes are formed on the bottom or upper surface of the truncated cone so as to divide the storage case into 12 equal parts. One end of each of tubular paint vessels 1 is inserted into the holes to radially arrange the paint vessels. The paint vessels may also be circularly arranged so as to constitute a hue circle by radially housing the paint vessels in a truncated cone-shaped housing case. Further, a construction may also be adopted in which a plurality of storage cases 13, 13a, and 13b with the paint vessels being radially arranged therein are provided and, as with the embodiment shown in FIG. 7, are arranged in a multi-stage form so that the stages are different from each other in brightness or tone. According to the paint set in this embodiment, a three-dimensional hue circle assembly is formed as a whole, and, thus, a higher learning effect on three attributes of colors and hue circles and a high function of rapid color selection can be obtained.

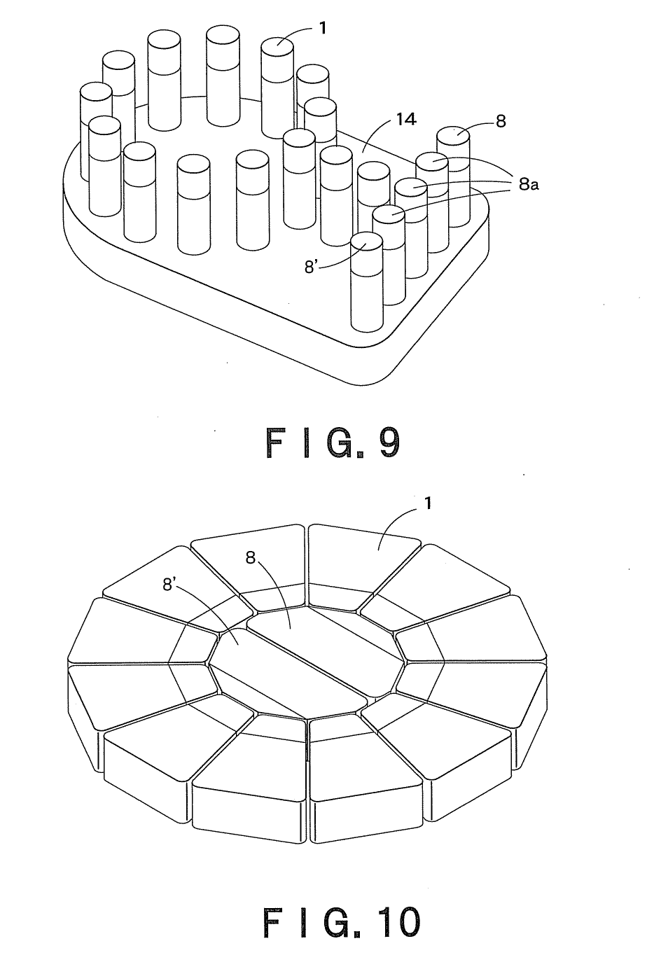

FIG. 9 is a perspective view of another embodiment of a paint set according to the present invention. The shape of the paint vessel storage case is different from that of the paint vessel storage case shown in FIG. 5. In this embodiment, a plurality of holes into which one ends of respective tubular paint vessels 1 can be fitted are formed in a storage case 14. The tubular paint vessels 1 are inserted into the holes to circularly arrange the chromatic color paints 1 filled into tubular vessels to constitute a hue circle. Further, as with the chromatic color paint vessels 1, a plurality of achromatic paint vessels may be arranged in a gray scale form indicating a brightness stage. A construction may also be adopted in which the achromatic paint vessels are arranged in the same manner as described above and intermediate achromatic paint (gray) vessels 8a are arranged, between white color and black color paint vessels 8, 8′, in a gray scale form indicating a brightness stage.

FIG. 10 is a perspective view of another embodiment of a paint set according to the present invention. In this embodiment, a construction is adopted in which a plurality of paint vessels 1 respectively filled with chromatic color paints each having a hue are circularly arranged so as to constitute a hue circle, and paint vessels 8, 8′ of white and black achromatic paints are arranged in the hue circle. The arrangement of the paint vessels in this manner makes unnecessary to use a paint storage case, and the storage case per se has an appearance that represents a hue circle. In this embodiment, any storage case for storing paint vessels is not used. However, it is a matter of course that the paint vessels may be stored in a storage case to fix the paint vessels.

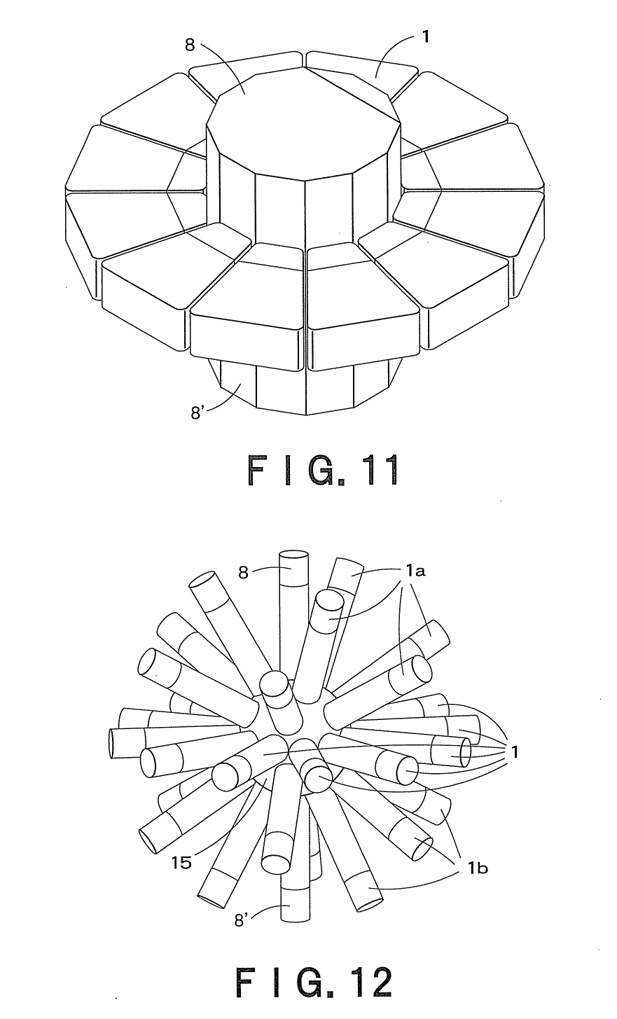

FIG. 11 is a perspective view of still another embodiment of a paint set according to the present invention. In this embodiment, the shape and arrangement of achromatic paint vessels 8, 8′ of a paint set are different from those shown in FIG. 10. In the embodiment shown in FIG. 11, a construction is adopted in which white and black achromatic paint vessels 8, 8′ are arranged so as to constitute poles opposite to each other with respect to a central axis of circularly arranged chromatic color paints 1. In this embodiment, as with the embodiment shown in FIG. 10, any storage case for storing paint vessels is not used. However, it is a matter of course that the paint vessels may be stored in the storage case to fix the paint vessels.

FIG. 12 is a perspective view of further embodiment of a paint set according to the present invention. In this embodiment, a paint vessel storage case 15 is spherical. Holes are provided on the surface of the spherical storage case 15 so that one end of each of tubular paint vessels 1 is fitted into the hole. The paint vessels can be stored by inserting tubular paint vessels into the holes. In the spherical storage case 15, achromatic paint vessels 8, 8′ are stored in holes provided in opposed pole positions of the spherical storage case 15. The chromatic color paint vessels 1 are circularly arranged so as to constitute a hue circle in a section formed by cutting out a sphere at a certain plane. A construction may also be adopted in which, even in a section obtained by cutting out a sphere at a plane different from the above plane, chromatic color paint vessels are arranged so as to constitute a hue circle, the chromatic color paint vessels 1a,1b being different from each other in brightness or tone. The arrangement of the chromatic color paint vessels in this manner can realize the formation of a more accurately three-dimensional hue circle assembly. Accordingly, a paint set having a very high learning effect on three attributes of colors and hue circles can be provided.

Various embodiments of the present invention have been described. However it should be noted that these embodiments are illustrative only and are not intended to limit the scope of the invention. Further, it is apparent to a person having ordinary skill in the art that various modifications and alterations are possible based on the embodiments. Accordingly, it is intended that all alterations and modifications fall within the scope of the invention.

### DESCRIPTION OF REFERENCE CHARACTERS

1: chromatic color paint vessels
1a, 1b: chromatic color paint vessels different from each other in brightness
2a, 2b: lid
3a, 3b: vessel body
4a, 4b: upper part of opening
5a,5b: bottom
6a: wedge-shaped surface
6b: trapezoidally shaped surface
7a, 7b: side surface of vessel
8,8′: achromatic (white and black) paint vessels
8a: achromatic (gray) paint vessel
9-15: storage case

1. A paint set comprising a plurality of paint vessels respectively filled with chromatic color paints each having a hue, the paint vessels being arranged circularly in a storage case to constitute a hue circle.

2. The paint set according to claim 1, wherein the hue circle is a hue circle of a Munsell color system or a hue circle of the Chamber of Commerce & Industry Color Coordination Chart (CCIC) color system.

3. The paint set according to claim 1, wherein the hue circle is a hue circle of a practical color co-ordinate system (PCCS), a hue circle of a natural color system (NCS), or an Ostwald hue circle.

4. The paint set according to claim 1, wherein the number of colors of the plurality of chromatic color paints is 10, 12, 20, or 24.

5. The paint set according to claim 1, wherein paint vessels respectively filled with chromatic color paints are tightly arranged adjacent to each other.

6. The paint set according to claim 1, wherein the vessels each comprise a lid and a vessel body and has been filled with a paint and the vessel body comprises a pair of surfaces formed in a wedge shape from the upper part of an opening engaged with the lid toward the bottom and a pair of rectangular side surfaces that connect the wedge-shaped surfaces.

7. The paint set according to claim 6, wherein the chromatic color paint vessels are arranged so that one of the pair of wedge-shaped surfaces in the vessel body faces upward relative to the storage case.

8. The paint set according to claim 7, wherein the chromatic color paint vessels are arranged so that the lid faces outward in the circle.

9. The paint set according to claim 1, wherein the vessels each comprise a lid and a vessel body and has been filled with a paint and the vessel body comprises a pair of surfaces in a trapezoidal shape widen from the upper part of an opening engaged with the lid toward the end and a pair of edge-shaped side surfaces that is formed from the upper part of the opening toward the bottom and connects the trapezoidal surfaces.

10. The paint set according to claim 9, wherein the chromatic color paint vessels are arranged so that one of the pair of trapezoidal surfaces in the vessel body faces upward relative to the storage case.

11. The paint set according to claim 10, wherein the chromatic color paint vessels are arranged so that the lid faces inward in the circle.

12. The paint set according to claim 7, wherein the chromatic color paint vessels are arranged in the storage case so that the surface, in the vessel body, that faces upward relative to the storage case is flat.

13. The paint set according to claim 6, wherein the vessel body is formed of a transparent or semi-transparent resin and the hue of the paint filled into the vessel can be perceived through the appearance of the vessel body.

14. The paint set according to claim 1, which further comprises a paint vessel that is filled with an achromatic paint and is provided at a position different from the position of the paint vessels filled with the chromatic color paints.

15. The paint set according to claim 14, wherein the color of the achromatic paint is white and/or black.

16. A paint set characterized by comprising a plurality of paint vessels respectively filled with chromatic color paints each having a hue, the plurality of paint vessels being circularly arranged to constitute a hue circle.
